(19) United States
(12) Patent Application Publication
(10) Pub. No.: US 2012/0163314 A1
(43) Pub. Date: Jun. 28, 2012

(54) METHOD AND APPARATUS OF SENDING FRAMES IN COGNITIVE RADIO SYSTEM

(75) Inventors: Il Gu LEE, Seoul (KR); Hun Sik KANG, Daejeon-si (KR); Sok Kyu LEE, Daejeon-si (KR)

(73) Assignee: Electronics and Telecommunications Research Institute, Daejeon-si (KR)

(21) Appl. No.: 13/333,665

(22) Filed: Dec. 21, 2011

(30) Foreign Application Priority Data
Dec. 23, 2010 (KR) 10-2010-0133434

(51) Int. Cl. H04W 72/04

(52) U.S. Cl. 370/329

(57) ABSTRACT

The present invention provides a method of a node sending frames in a Cognitive Radio (CR) system. The method of the node includes being allocated a first channel as an operating channel where the node will be operated, sensing one or more candidate channels available as the operating channel of the node, determining whether to extend a frequency bandwidth of the operating channel, in addition to the first channel, based on a result of the sense for the one or more candidate channels, and sending the frames using a frequency bandwidth extended by adding a second channel, newly determined as the operating channel, to the first channel according to the determination.

### CROSS-REFERENCE TO RELATED APPLICATIONS

This application claims the benefit of priority of Korean Patent application No. 10-2010-0133434 filed on Dec. 23, 2010, all of which are incorporated by reference in their entirety herein.

### BACKGROUND OF THE INVENTION

1. Field of the Invention

The present invention relates to wireless communication and, more particularly, to a method and apparatus for sending frames in a Cognitive Radio (CR) communication system.

2. Discussion of the Related Art

With the rapid growth of wireless communication systems and the development of various wireless communication services, a strict frequency band is required in order to solve the coexistence problem between the existing communication systems. However, frequency resources for a new platform are insufficient because almost all the frequency bands commercially available have been allocated. In a current frequency use condition, there is almost no room to use several GHz band or less (particularly, low frequency bands). In order to solve the frequency shortage problem, there has recently been suggested an intelligent CR concept in which a frequency band that has been allocated, but is empty without being actually used is detected and efficiently used.

In the existing wireless communication systems, nations have strictly controlled frequency resources according to their frequency policies. Accordingly, governments have approved and allocated frequency resources to service providers. Unlike the existing wireless communication systems, the intelligent CR system uses frequency resources, allocated, but not used, without interfering with wireless communication of the existing service providers.

In line with the recent sudden increase of a demand for short frequency resources, a necessity for the CR technique has emerged. There is a lot of interest in the intelligent CR technique and lots of researches are being done on the intelligent CR technique since the possibility of using frequencies in common was mentioned in NPRM (Notice of Proposed Rule Making) of the Federal Communications Commission (FCC) (U.S.A) on December, 2003. As a representative example, for the development purposes of a communication platform using the intelligent CR technique, IEEE 802.22 WRAN (Wireless Regional Area Networks) has been standardized. Targets in which the IEEE 802.22 WRAN will be used include the outskirts of cities of U.S.A. or CANADA or developing countries. The IEEE 802.22 WRAN is intended to provide wireless communication service by applying an intelligent wireless communication technique to unused TV bands.

The standardization and development for the CR technique, although it is being activated, is in the early stage. Accordingly, many problems to be solved exist, and most of constituting techniques have not yet been determined.

A CR terminal operating in a CR communication system jointly uses an unlicensed band with the other communication system. Accordingly, it should be assumed that there is interference from the other communication system in addition to common noise existing in a wireless communication system and the interference hinders communication.

In view of the characteristic of the environment, it is necessary to take the influence of the same kind or a different kind of a communication system and the influence of its own transmission on the other communication system into consideration when a radio frame is sought to be transmitted. Furthermore, available channels are also changed according to a change of a continuously changing communication environment. In general, assuming that other conditions are the same, the transmission rate of data may be proportional to the bandwidth of a used channel. Accordingly, it may be necessary to adaptively determine the bandwidth of a used channel or aggregate a plurality of channels according to a change of a channel condition in which the terminal of a CR system with varying available channels is operating. The present invention provides a method and apparatus for solving the above problems.

### SUMMARY OF THE INVENTION

It is an object of the present invention to provide a method and apparatus for cognitively sending and received frames according to a change of an environment through control of a bandwidth mode, transmission power, and a beamforming mode.

### BRIEF DESCRIPTION OF THE DRAWINGS

The above and other objects and features of the present invention will become apparent from the following description of preferred embodiments given in conjunction with the accompanying drawings, in which:

FIG. 1 is a simplified diagram showing an example of the configuration of a WLAN system to which an embodiment of the present invention may be applied;

FIG. 2 shows the frequency band which can be operated per 20 MHz band in the entire 160 MHz bandwidth;

FIG. 3 is a flowchart illustrating a procedure of determining and switching a transmission bandwidth according to an embodiment of the present invention;

FIG. 4 shows the configuration of a network for helping understanding of the present invention;

FIG. 5 shows an example of an OBSS environment;

FIG. 6 shows an example of the avoidance of interference employing beamforming;

FIG. 7 shows an embodiment of the present invention; and

FIG. 8 is a block diagram of a wireless apparatus in which an embodiment of the present invention is implemented.

### DETAILED DESCRIPTION OF THE EMBODIMENTS

Hereinafter, embodiments of the present invention are described in detail with reference to the accompanying drawings. The following embodiments may be usefully applied to a CR (Cognitive Radio) communication system. The CR system may include wireless communication systems supporting, for example, IEEE 802.11, IEEE 802.22, and ECMA 392 standards. An example in which the CR communication system is applied to an IEEE 802.11 WLAN system is described below, but the present invention is not limited thereto. The present invention may be applied to a CR system operating in a frequency band in which the same kind or different kinds of communication systems coexist. In the following embodiments, terms unique in the IEEE 802.11 WLAN system may be replaced or substituted with terms unique in other systems when the IEEE 802.11 WLAN system is applied to other systems.

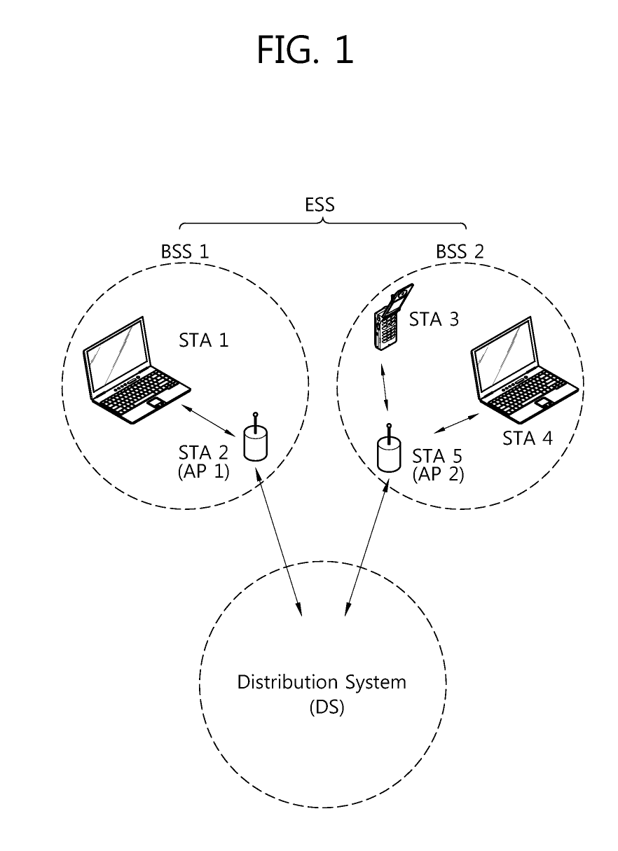

FIG. 1 is a simplified diagram showing an example of the configuration of a WLAN system to which an embodiment of the present invention may be applied. Referring to FIG. 1, the WLAN system includes one or more Basic Service

Sets (BSS). The BSS is a set of stations (STA) which are successfully synchronized to communicate with each other and is not a concept indicating a specific area. The BSS may be divided into an infrastructure BSS and an independent BSS (IBSS). FIG. 1 shows infrastructure BSSs. The infrastructure BSSs BSS1 and BSS2 include one or more STAs STA1, STA3, STA4, Access Points (AP) (that is, an STA providing distribution service), and a Distribution System (DS) connecting the plurality of APs AP1 and AP2. Meanwhile, the IBSS includes only mobile STAs because it does not include an AP and forms a self-contained network because it is not allowed to access a DS.

An STA is a certain function medium, including Medium Access Control (MAC) and a physical layer interface for a radio medium according to the IEEE 802.11 standard, and it includes both an AP and a non-AP STA in a broad sense.

In a VHT WLAN system to which an embodiment of the present invention is applicable, the STAs included in the above BSS may all be VHT STAs supporting the IEEE 802.11ac standard, or HT STAs (supporting the IEEE 802.11n standard) or legacy STAs (e.g., non-HT STAs supporting the IEEE 802.11a/b/g standards) may coexist in the above BSS.

Handheld terminal manipulated by users, from among the STAs, include non-AP STAs STA1, STA3, and STA4. The STA may be simply referred to as a non-AP STA. The non-AP STA may also be called another term, such as a terminal, a Wireless Transmit/Receive Unit (WTRU), User Equipment (UE), a Mobile Station (MS), a Mobile Terminal (MT), or a Mobile Subscriber Unit (MSU).

The APs AP1 and AP2 are function media for providing access to the DS via a radio medium for the STAs associated therewith. In an infrastructure BSS including an AP, communication between non-AP STAs is basically performed through the AP. However, in the case where a direct link is set up between the non-AP STAs, the non-AP STAs may directly communicate with each other.

An AP may also be referred to as another term, such as a centralized controller, a Base Station (BS), a node-B, a Base Transceiver System (BTS), or a site controller. An AP supporting ultra-high data processing of 1 GHz or higher, supporting SDMA to be described later, is called a VHT AP.

The plurality of infrastructure BSSs may be interconnected through the DS. The plurality of BSSs interconnected through the DS is called an Extended Service Set (ESS). The STAs included in the ESS may communicate with each other, and non-AP STAs may move from one BSS to another BSS while seamlessly communicating with each other within the same ESS.

The DS is a mechanism in which one AP communicates with the other AP. According to the mechanism, an AP may transmit frames to STAs coupled to a BSS managed by the AP, transfer frames to any one STA in the case where any one STA moves to another BSS, or transfer frames to an external network, such as a wired network. The DS needs not to be necessarily a network, and it is not limited to any form so long as it can provide distribution service defined in the IEEE 802.11 standard. For example, the DS may be a wireless network, such as a mesh network, or a physical structure interconnecting APs.

In describing the embodiments of the present invention hereinafter, a node refers to an STA and an AP. In other words, a node may be an AP or an STA (or non-AP STA), unless specially described.

According to an embodiment of the present invention, in a wireless communication system, the throughput of a network can be improved by a combination of three kinds of constituting elements. The three kinds of constituent elements may include automatic node selection and access based on path loss information and determination of transmission power based on path loss between nodes, determination of a use bandwidth based on the path loss information and according to whether neighboring frequencies are used, and a beamforming technique capable of securing a wider channel bandwidth for high-speed transmission. In the three kinds of constituent elements, the bandwidths and transmission powers of the nodes of a network are determined from a point of view of maximizing the throughput and minimizing power consumption.

The operating principle of the three kinds of constituent elements is described below.

According to the present invention, a node trying to transmit frames may automatically access a node having the smallest path loss on the basis of path loss information. Two different nodes sending and received frames may find path loss information on the basis of the strength of a received signal in accordance with Equation 1.

PL=TPG1−RSSI1 [Equation 1]

In Equation 1, the PL (Path Loss) is a calculated path loss value, and the TPG1 (Transmit Power Gain) is a gain value of a transmission power gain field written in a received frame. The RSSI1 (Received Signal Strength Indicator) is a measured value of a received signal strength of the received frame.

TPG2=RSSI2−PL+RG [Equation 2]

A minimum transmission power strength for transferring a signal to a counterpart node that will receive the signal without error can be calculated based on path loss information. In Equation 2, the TPG2 is a transmission power gain value of a next transmission frame. The RSSI2 is a received signal strength value written in the received signal strength field of a received frame. The PL is a path loss value calculated by Equation 1. The RG is a gain for satisfying required performance. To this end, the present invention employs a method of carrying two pieces of information TPG and RSSI on a transmission packet and sending the transmission packet.

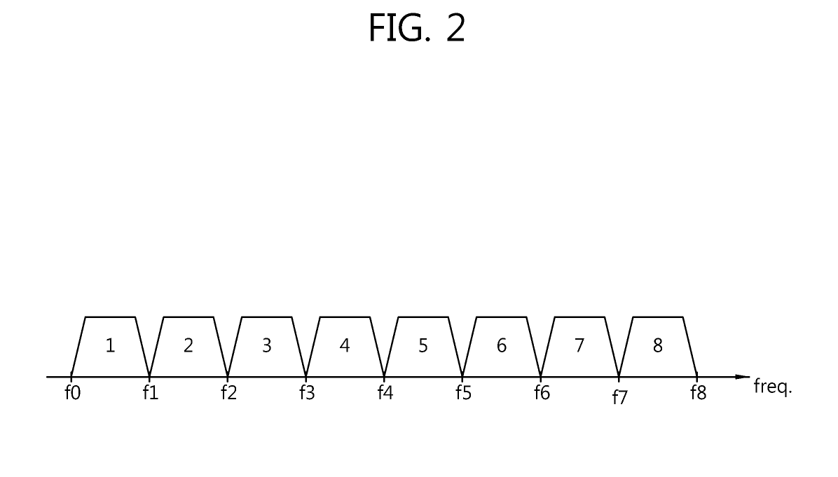

FIG. 2 shows the frequency band which can be operated per 20 MHz band in the entire 160 MHz bandwidth. FIG. 2 is only an example of a channel configuration, and one channel may be configured in various ways, such as 5 MHz, 6 MHz, 10 MHz, or 40 MHz. The operating channel of a node may also be configured in various ways, such as 5, 10, 20, 40, 80, 120, or 160 MHz.

It is hereinafter assumed that a node is a wireless communication system that can be operated in a 20, 40, 80, 120, or 160 MHz bandwidth mode.

The node may determine whether there is a signal in frequency bands 80 MHz higher or lower than a center frequency now being used. A node may determine whether a signal exists in a corresponding frequency band by directly sensing the corresponding band or by acquiring information about whether the signal exists in another channel (in other words, whether another channel is being used by other communication system) from another node (e.g., AP).

In the case where a node directly senses a corresponding channel in order to determine whether a signal exists in the corresponding channel, such sense may be based on a signal correlation, energy detection, or a method of detecting a saturation state of an analog digital converter. For example, in a BSS consisting of nodes which transmit and receive data per 40 MHz bandwidth using Nos. 4 and 5 frequency bands at the center frequency f4 of FIG. 2, the nodes may sense whether neighboring frequency bands (i.e., Nos. 1, 2, 3, 6, 7, and 8 frequency bands) are being used by other nodes on a regular basis. If, as a result of the sense, the Nos. 3 and 6 frequency bands are not used, the nodes belonging to the BSS may switch from the 40 MHz mode to an 80 MHz mode and transmit and receive frames using the 80 MHz bandwidth in order to increase the throughput. If the Nos. 2, 3, 6, and 7 frequency bands are not used, the nodes may switch to a 120 MHz mode and transmit and receive frames using the 120 MHz bandwidth. If the Nos. 1, 2, 3, 6, 7, and 8 frequency bands are not used, the node may switch to a 160 MHz mode and transmit and receive frames using the 160 MHz bandwidth. Hereinafter, when describing that any node is operated in a K MHz mode, it means that the corresponding node sends and receives frames using the K MHz bandwidth.

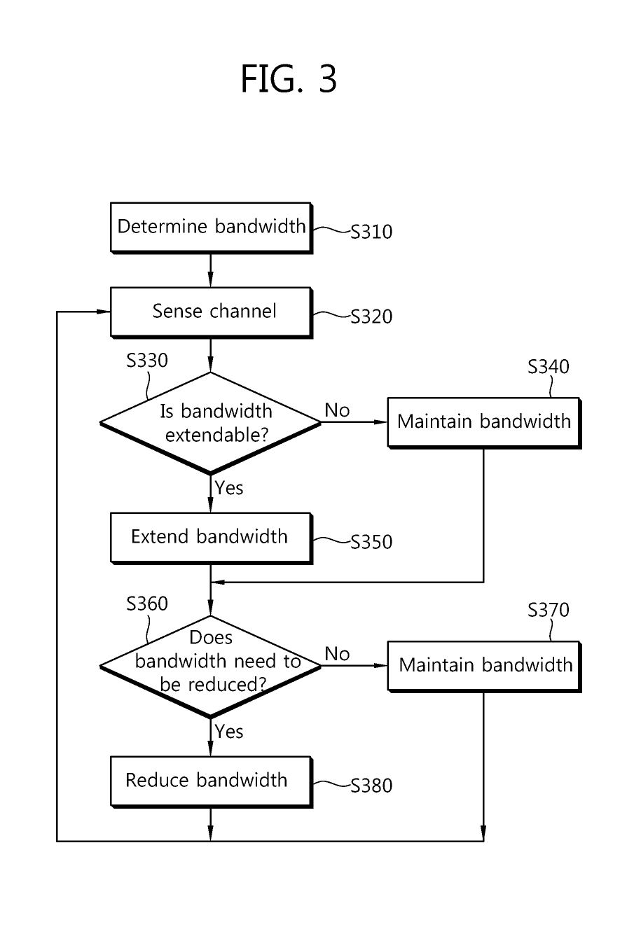

FIG. 3 is a flowchart illustrating a procedure of determining and switching a transmission bandwidth according to an embodiment of the present invention.

A node trying to transmit and receive frames determines a bandwidth in which the node will be operated at step S310. The operating bandwidth may be allocated to the node in a process of the node being combined with a BSS or may be determined through a conference with a counterpart node. For example, in an IEEE 802.11 system, an AP may allocate a channel and bandwidth to an STA.

Next, the node senses neighboring channels at step S320. Referring to FIG. 2, a node using the No. 4 channel having a 20 MHz bandwidth as an operating channel may sense the Nos. 1 to 3 or 5 to 8 channels. The node checks whether other signals exist in the corresponding channels by sensing the channels.

The node determines whether the bandwidth of a frequency band to be used can be extended on the basis of the information about whether other signals exist in the corresponding channels at step S330. If no signal is detected in the No. 3 channel as a result of a sense of a node operated in the No. 4 channel, a 20 MHz bandwidth of the No. 3 channel may be determined to be extended. That is, whether a bandwidth can be extended may be determined by whether a target channel to be extended is being used by another user (if another signals exists in the channel, the channel may be determined to be used by another user). If, although a corresponding channel is not used by another user, the use of the corresponding channel in a condition that channels neighboring the corresponding channel are being used by another user may probably interfere with another user having the order of priority or if it is certainly known that a user having the order of priority for using a corresponding channel will soon use the corresponding channel, extension to the corresponding channel may not be performed.

If, as a result of the determination at step S330, the bandwidth of the frequency band to be used is determined not to be extended or the extension of the bandwidth is inappropriate, the node maintains the existing bandwidth at step S340. If, as a result of the determination at step S330, the bandwidth of the frequency band to be used is determined to be extended and extension to a corresponding channel is preferred, the node extends the used bandwidth at step S350. For example, if a terminal using the No. 4 channel of FIG. 2 (that is, operating in the 20 MHz mode) determines that the No. 4 channel can be extended to the No. 5 channel as a result of the determination based on the above procedure, the terminal may switch to the 40 MHz mode through the extension of the bandwidth by using the No. 5 channel as the operating channel. During the time for which the terminal is operated in the 40 MHz mode, the terminal may determine whether additional extension is possible by sensing neighboring channels.

Next, the node may determine whether the bandwidth needs to be reduced at step S360. Whether the bandwidth needs to be reduced may be determined by the node on a regular basis or may be performed in the case where another node (e.g., AP) requests the bandwidth to be adjusted or in the case where the bandwidth needs to be adjusted owing to a reduction of the transmission/reception performance (e.g., the transmission/reception performance falls below a predetermined critical value). A reduction of the bandwidth may be performed in the case where a user having the order of priority for using a corresponding channel starts using the corresponding channel, in the case where interference becomes serious because of the use of the corresponding channel by another user, or in the case where performance is reduced because of collision between signals.

If, as a result of the determination at step S360, the bandwidth is determined to be needed to be reduced, the node may reduce the bandwidth at step S380. If, as a result of the determination at step S360, the bandwidth is determined not to be needed to be reduced, the node may maintain the bandwidth at step S370. Although the bandwidth has been determined to be needed to be reduced and reduced, if it is subsequently determined that the bandwidth can be extended through sense, the bandwidth may be extended.

In the bandwidth switching process, a protection mechanism for prohibiting neighboring nodes from accessing a channel for a certain period of time with respect to an extended bandwidth through a Request To Send (RTS) frame/Clear To Send (CTS) frame exchange procedure in order to occupy the channel for a transmit opportunity (hereinafter referred to as ‘TXOP’) may also be used.

If it is determined that a channel can be extended as a result of channel sense, the RTS frame/CTS frame is also copied to an extendable band, duplicated, and transmitted. Accordingly, nodes operating in the extendable band are prevented from accessing an extended band during the TXOP period.

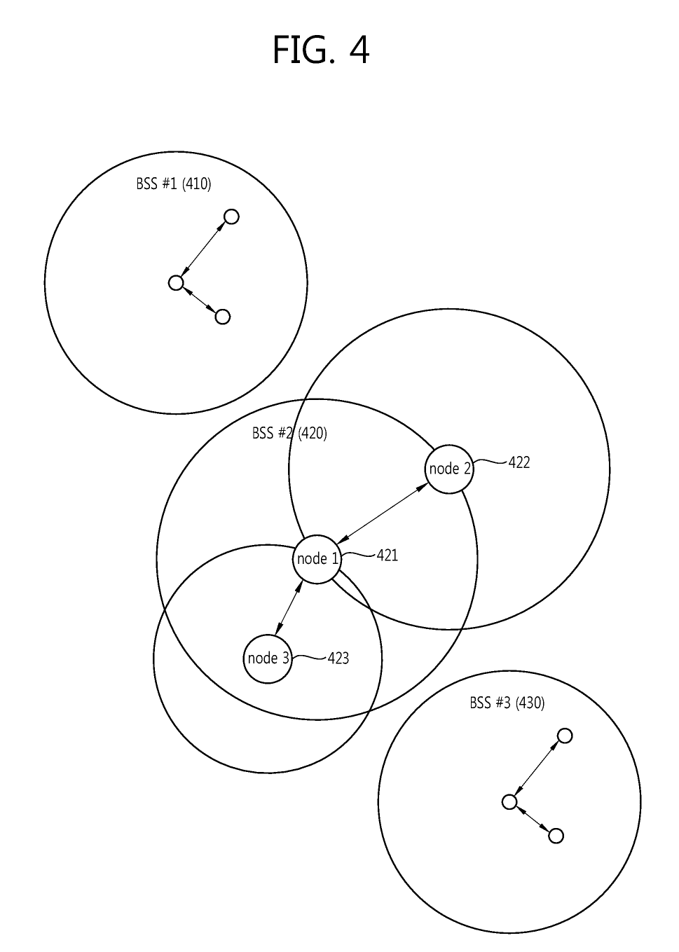

FIG. 4 shows the configuration of a network for helping understanding of the present invention. It is assumed that the network includes three BSSs; a BSS #1 410, a BSS #2 420, and a BSS #3 430 and nodes are deployed as shown in FIG. 4.

Each of a node1 421, a node2 422, and a node3 423 of the BSS #2 420 determines a minimum transmission power by calculating path loss with a node to which transmission power will be connected in accordance with the present invention. After all the node1 421, node2 422, and node3 423 calculate the minimum transmission powers, they determine whether to extend bandwidths according to a sense result regarding whether neighboring nodes are using neighboring frequency channels. The BSS #2 420 has an independent area from neighboring BSSs and thus can determine a use frequency band irrespective of whether the BSS #1 410 and the BSS #3 430 use which frequency bands.

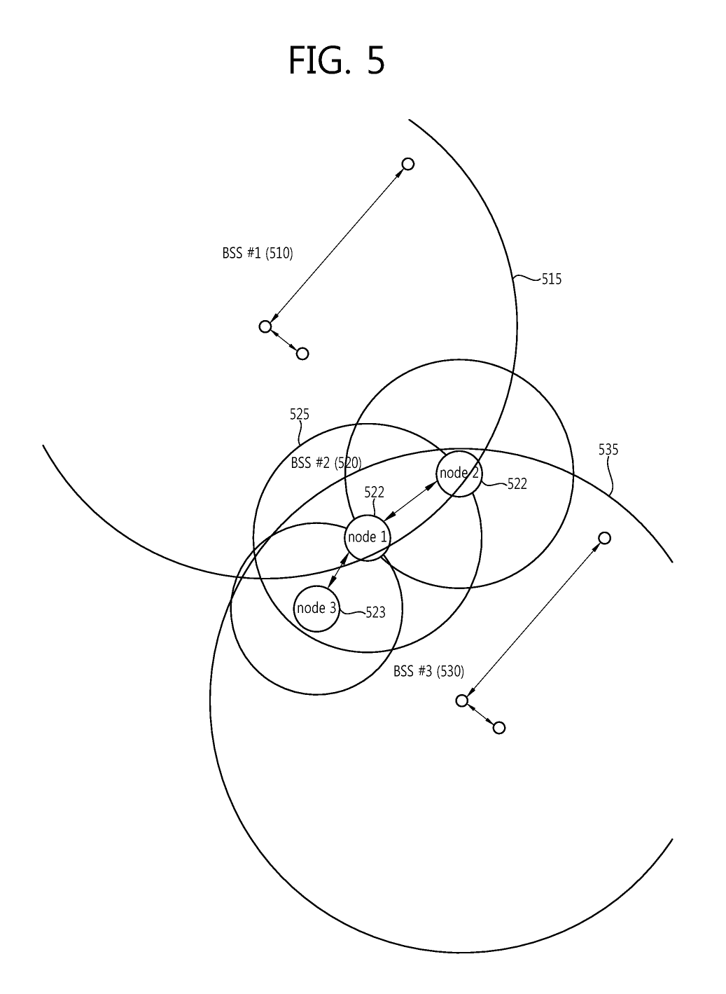

FIG. 5 shows an example of an Overlapping BBS (OBSS) environment.

In the case where the propagation ranges of neighboring BSS#1 510 and BSS#3 530 are wide and thus overlapped with the propagation range of a BSS#2 520 as shown in FIG. 5, the same frequency band may not be used as in FIG. 4. If the BSS #1 510 uses the No. 1 frequency band from among the frequency bands and the BSS #3 530 uses the No. 8 frequency band from among the frequency bands, the BSS #2 520 may use the Nos. 2, 3, 4, 5, 6, and 7 frequency bands, extend to a 120 MHz bandwidth mode, and transmit and receive frames using the 120 MHz bandwidth. Nodes included in the BSS #2 520 may transmit and receive frames using the Nos. 2 to 7 frequency bands. If there is collision between signals, a use bandwidth has to be reduced as shown in FIG. 3.

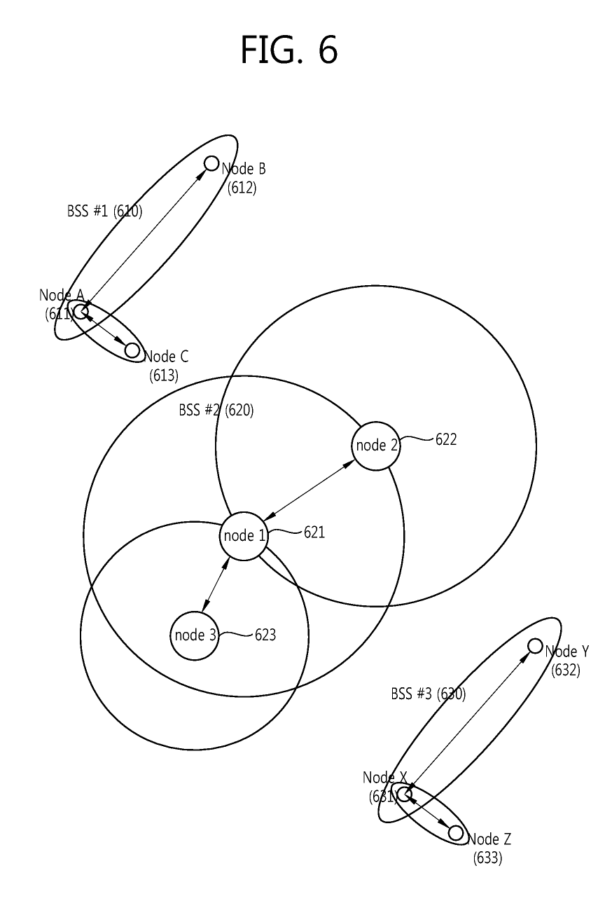

FIG. 6 shows a case where beamforming is used in a BSS #1 610 and a BSS #3 630 in order to solve the problem that the propagation ranges of the BSS #1 510 and the BSS #3 530 are wide and overlapped with the propagation range of the BSS #2 520 as in FIG. 5. If the propagation ranges are not overlapped using beamforming, an available bandwidth of a BSS #2 620 can be increased. That is, a node trying to transmit frames in the BSS #3 630 determines a beamforming matrix for beamforming such that transmission through beamforming in its BSS #3 630 does not serve to interfere with the transmission and reception of frames in the BSS #1 610.

Assuming that a plurality of nodes using the same frequency band exists in an IEEE 802.11 system, if any transmission node acquires a right to possess a channel (e.g. in the case where a transmission node has accessed a channel through a back-off procedure or where a transmission node is assigned a contention-based or a non-contention-based TXOP), other nodes has to set a Network Allocation Vector (NAV) during the time for which the transmission node possesses the channel and defer access to the corresponding channel. Consequently, efficiency in channel use is very low.

However, in the example of FIG. 6, during the TXOP period where any transmission node possesses a channel, a third node can transmit and receive frames to and from another node using beamforming without interfering with the transmission node sending frames to a target node on the basis of an NAV value.

The example of FIG. 6 shows an example in which beamforming is used as a method of reducing interference between nodes operating in different BSSs. However, the example of FIG. 6 may also be used to reduce interference between nodes which use the same channel in the same BSS in the same manner. That is, in a condition that a first transmission node sends frames to a first reception node within the same BSS, a second transmission node may transmit frames to a second reception node using beamforming during the TXOP period of the first transmission node without interfering with the transmission of the first transmission node. As a detailed example, when frames are transmitted and received between an AP and an STA1, frames are transmitted and received between an STA 2 and an STA 3. Accordingly, the use efficiency of radio resources can be increased, and the throughput of a system can be improved.

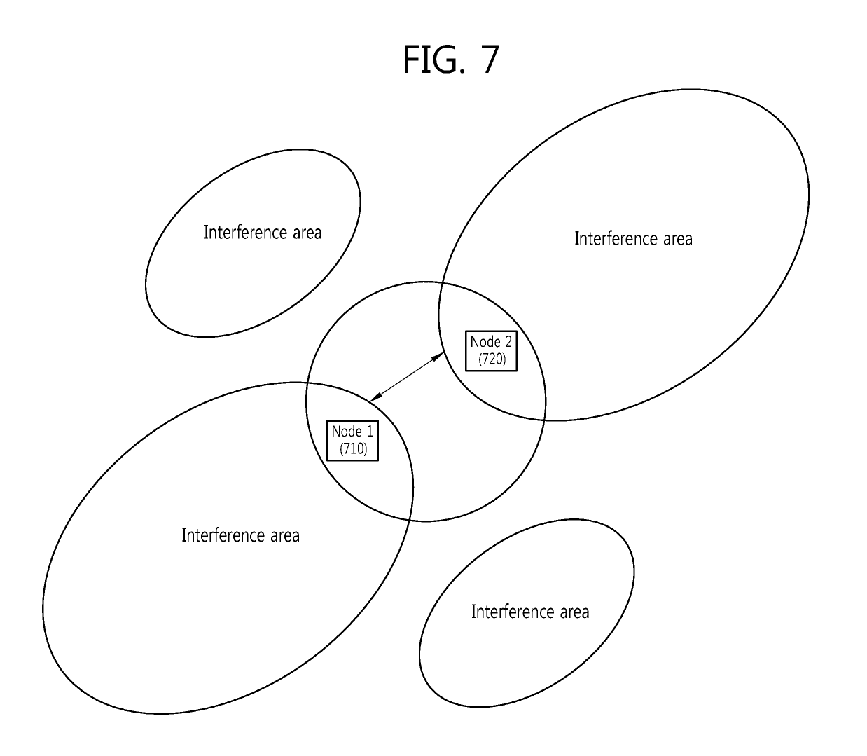

FIG. 7 shows an embodiment of the present invention.

It is assumed that a Node 1 710 and a Node 2 720 of FIG. 7 (e.g., a notebook computer and a multimedia apparatus) are located at a short way off as shown in FIG. 7 and surrounding interference signals exist. The surrounding interference signals are generated by the same kind or different kinds of communication systems, and areas where interference is reached are indicated by interference areas in FIG. 7. If a transmission power between the notebook computer and the multimedia apparatus can be controlled such that the interference signals do not overlap with each other, a maximum available frequency bandwidth can be used, and thus the throughput becomes a maximum. Meanwhile, in the case where the interference signals overlap with each other, wireless transmission between the notebook computer and the multimedia apparatus may be performed by avoiding frequency bands where the interference signals exist through channel sensing and using an available frequency bandwidth to the greatest extent. Furthermore, propagation ranges may not overlap with each other through signal beamforming of neighboring BSSs, and thus a maximum frequency bandwidth can be used.

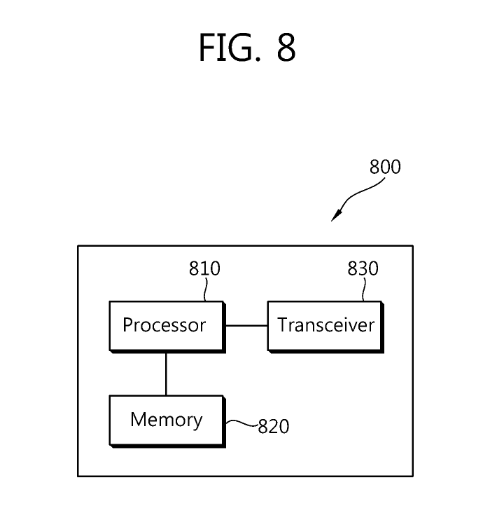

FIG. 8 is a block diagram of a wireless apparatus in which an embodiment of the present invention is implemented.

The wireless apparatus 800 may include a processor 810, memory 820, and a transceiver 830. The transceiver 830 may have a plurality of Network Interface Card (NICs). The processor 810 is functionally coupled to the transceiver 830 and configured to adjust a transmission power, perform beamforming, and extend and reduce a bandwidth according to the methods proposed by the present invention, generate frames therefor, and process received frames. The processor 810 and the transceiver 830 may implement the physical layer and the MAC layer of IEEE 802.11. The processor 810 or the transceiver 830 or both may include Application-Specific Integrated Circuits (ASIC), other chipsets, logic circuits, and/or data processors. The memory 820 may include Read-Only Memory (ROM), Random Access Memory (RAM), flash memory, a memory card, a storage medium and/or other storage devices. When the embodiment is implemented in software, the above method may be implemented using a module, process, or function for performing the above functions. The module may be stored in the memory 820 and executed by the processor 810. The memory 820 may be external or internal to the processor 810 and may be connected to the processor 810 by well-known means. The wireless apparatus 800 may be operated as a terminal which supports the IEEE 802.22 standard or a terminal for CR communication which supports the ECMA 392 standard according to a wireless communication protocol and setting implemented in the processor 810.

A transmission power is controlled and used so that interference signals do not overlap with each other, and a maximum available frequency bandwidth can be used. Accordingly, the throughput of a communication system can be improved.

The above-described embodiments include various aspects of illustrations. Although all the possible combinations for describing the various aspects may not be described, a person having ordinary skill in the art may appreciate that other combinations are possible. Accordingly, the present invention should be construed to include all other replacement, modifications, and changes which fall within the claims

What is claimed is:

1. A method of transmitting a frame, performed by a node, in a Cognitive Radio (CR) system, the method comprising:
being allocated a first channel as an operating channel where the node operate;
sensing one or more candidate channels available as the operating channel of the node;
determining whether to extend a frequency bandwidth of the operating channel, in addition to the first channel, based on a result of the sense for the one or more candidate channels; and
transmitting a frame via a frequency bandwidth extended by adding a second channel, newly determined as the operating channel, to the first channel according to the determination.

2. The method of claim 1, wherein the second channel is contiguous to the first channel.

3. The method of claim 1, wherein each of the first channel and the one or more candidate channels has a frequency bandwidth of 20 MHz.

4. The method of claim 1, wherein determining whether to extend the frequency bandwidth of the operating channel in addition to the first channel comprises:
determining whether the one or more candidate channels are being used as a result of the sense for the one or more candidate channels by detecting a signal; and
if a signal is not detected as a result of the detection, determining to extend the frequency bandwidth to a frequency band of the one or more candidate channels where the signal has not been detected.

5. The method of claim 1, further comprising:
if the second channel is determined as the operating channel in addition to the first channel, sending a Request To Send (RTS) frame through the first channel and the second channel prior to sending the frames, and
receiving a Clear To Send (CTS) frame in response to the RTS frame.

6. A method of transmitting a frame, performed by a node, in a CR system, the method comprising:
being allocated a first channel and a second channel as operating channels where the node operate;
transmitting a frame via the first channel and the second channel;
sensing channels neighboring the operating channels;
determining whether to extend or reduce a bandwidth of the operating channels based on a result of the sense and based on whether interference exists in any one of the operating channels; and
transmitting a frame through an operating channel having a new frequency bandwidth extended or reduced according to a result of the determination.

7. A wireless apparatus operating in a CR communication system, comprising:
a transceiver configured to transmit or receive frames; and
a processor operatively coupled to the transceiver,
wherein the processor is configured to:
be allocated a first channel as an operating channel where the wireless apparatus operate;
sense one or more candidate channels available as the operating channel of the wireless apparatus;
determine whether to extend a frequency bandwidth of the operating channel, in addition to the first channel, based on a result of the sense for the one or more candidate channels; and
transmit the frames via a frequency bandwidth extended by adding a second channel, newly determined as the operating channel, to the first channel according to the determination.

8. The wireless apparatus of claim 7, wherein the second channel is contiguous to the first channel.

9. The wireless apparatus of claim 7, wherein each of the first channel and the one or more candidate channels has a frequency bandwidth of 20 MHz.

10. The wireless apparatus of claim 7, wherein the processor is further configured to:
determine whether the one or more candidate channels are being used as a result of the sense for the one or more candidate channels by detecting a signal, and
if a signal is not detected as a result of the detection, determine whether to extend the frequency bandwidth of the operating channel in addition to the first channel by extending the frequency bandwidth of the operating channel to a frequency band of the one or more candidate channels where the signal has not been detected.

11. The wireless apparatus of claim 7, wherein the processor is further configured to send an RTS frame through the first channel and the second channel prior to sending the frames and receive a CTS frame in response to the RTS frame, if the second channel is determined as the operating channel in addition to the first channel.

12. A method of transmitting a frame, performed by transmission node, in a CR system, the method comprising:
transmitting a first frame to a reception node using beamforming,
wherein a beamforming matrix used in the beamforming transmission is determined so that the transmission of the first frame of the transmission node does not serve as interference with a third node sending a second frame to a fourth node or with the fourth node receiving the second frame, when the transmission node sends the first frame

13. The method of claim 12, wherein the third node and the fourth node are operated in a same Basic Service Set (BSS) as the transmission node or in a BSS neighboring a BSS where the transmission node is operated.

14. The method of claim 12, wherein the transmission of the first frame of the transmission node is performed within a period where the third node possesses a channel.
